(19) United States
(12) Patent Application Publication
(10) Pub. No.: US 2005/0179872 A1
(43) Pub. Date: Aug. 18, 2005

(54) Projector

(75) Inventor: Koichi Akiyama, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/039,915

(22) Filed: Jan. 24, 2005

(30) Foreign Application Priority Data
Jan. 26, 2004 (JP) 2004-017255

(51) Int. Cl. G03B 21/00

(52) U.S. Cl. 353/31

(57) ABSTRACT

A projector where efficiency of light utilization will not be significantly reduced, even when configured to enable high-quality moving pictures to be displayed smoothly, includes an illumination device, liquid crystal displays, and a projection system to project lights modulated in these liquid crystal displays. The projector further includes a plurality of small lenses in a first lens array being of a planar shape compressed in the length direction to enable an illumination light to illuminate the entire image forming region as to the width direction of the image forming region in each liquid crystal display device and a part of the image forming region as to the length direction. The projector also includes a rotating prism to scan an illumination light across the image forming region along the y-axis direction in sync with a screen writing frequency of the liquid crystal displays.

### BACKGROUND

Exemplary embodiments of the present invention relate to a projector.

FIGS. 13A-13C are schematics that describe a projector of the related art. FIG. 13(A) shows an optical system in the projector of the related art. FIG. 13(B) and FIG. 13(C) explain problems with the projector of the related art.

In a projector 900A, liquid crystal displays 400R, 400G, and 400B used as electro-optic modulation devices are hold-type display devices having luminance characteristics as are shown in FIG. 13(B). Hence, different from CRTs, which are impulse-type display devices having luminance characteristics as are shown in FIG. 13(C), it has a problem that moving pictures cannot be displayed smoothly due to a so-called tailing phenomenon (for example, as to the tailing phenomenon, see “Hourudo-gata disupurei niokeru douga-hyouji no gashitsu” IEICE Technical Report, EID99-10, pp. 55-60, (1999-June)).

FIGS. 14A-14C are schematics that describe another projector of the related art. FIG. 14(A) shows an optical system in another projector of the related art. FIG. 14(B) and FIG. 14(C) show optical shutters used in another projector of the related art.

In a projector 900B, as is shown in FIG. 14(A), optical shutters 420R, 420G, and 420B are provided, respectively, for the liquid crystal displays 400R, 400G, and 400B on their light incident-sides in addressing or solving the problem described above by shielding lights intermittently with the use of these optical shutters. In short, high-quality moving pictures can be displayed smoothly by easing a so-called tailing phenomenon (for example, see JP-A-2002-148712 (FIG. 1 through FIG. 7)).

### SUMMARY

Another projector of the related art, however, is subject to a problem in that efficiency of light utilization is reduced markedly because lights are shielded intermittently by the optical shutters.

An exemplary embodiment of the present invention addresses or solves the above and/or other problems, and provides a projector with which efficiency of light utilization will not be reduced markedly even when configured to enable high-quality moving pictures to be displayed smoothly.

(1) In an exemplary embodiment, a projector is provided with: an illumination device including a light source to emit a substantially parallel illumination light toward an illuminated region, a first lens array having plural small lenses to divide the illumination light from the light source into plural partial lights, a second lens array having plural small lenses respectively corresponding to the plural small lenses in the first lens array, and a superimposing lens to superimpose respective partial lights from the second lens array onto the illuminated region; an electro-optic modulation device to modulate an illumination light from the illumination device according to image information; and a projection system to project a light modulated by the electro-optic modulation device. In the projector, each of the plural small lenses in the first lens array is configured to change the illumination light from the illumination device to an illumination light having a profile, such that the illumination light illuminates an entire image forming region as to either one of length and width directions of the image forming region in the electro-optic modulation device and a part of the image forming region in the other direction, and is thereby of a planar shape compressed in the other direction. A scanning device is provided to scan the illumination light across the image forming region along the other direction in sync with a screen writing frequency of the electro-optic modulation device further provided between the illumination device and the electro-optic modulation device.

In an exemplary embodiment, it is possible to scan an illumination light, having a profile such that the illumination light illuminates an entire image forming region to either one of length and width directions of the image forming region in the electro-optic modulation device and a part of the image forming region to the other direction (that is, a profile compressed in the other direction), across the forming region along the other direction in sync with the screen writing frequency of the electro-optic modulation device. A light irradiated region and a light non-irradiated region are thus scrolled successively in turn on the image forming region in the electro-optic modulation device. This eases a tailing phenomenon, and the projector thus serves as a projector capable of displaying high-quality moving pictures smoothly.

Also, according to the projector of the exemplary embodiment, an illumination light having the profile compressed in the other direction as described above is achieved by using, as the first lens array, a lens array in which respective small lenses are of a planar shape compressed in the other direction. Hence, different from the case of using the optical shutters, it is possible to guide an illumination light from the light source to the image forming region in the electro-optic modulation device while eliminating wastes, which can in turn prevent efficiency of light utilization from being reduced markedly.

The projector of the exemplary embodiment thus serves as a projector with which efficiency of light utilization will not be reduced markedly even when configured to enable high-quality moving pictures to be displayed smoothly, and the object of the invention can be thereby achieved.

Because “a rectangle having a ratio of a length dimension to a width direction=3:4” and “a rectangle having a ratio of a length dimension to a width direction=9:16” are widely used as a planar shape of the image forming region in the electro-optic modulation device, “a rectangle having a ratio of a length dimension to a width direction=3:8”, “a rectangle having a ratio of a length dimension to a width direction=9:32”, or “a rectangle having a ratio of a length dimension to a width direction=1:2” can be used suitably as a planar shape of each small lens in the first lens array for the projector set forth in (1).

(2) For the projector set forth in (1), it is preferable that respective small lenses in the first lens array are aligned in two columns with an illumination optical axis in between.

When configured in this manner, respective partial lights from the first lens array are aligned in one column with the illumination optical axis in between on the second lens array. It is thus possible to effectively reduce or suppress a reduction in efficiency of light utilization caused when respective partial lights are separated unsatisfactorily in the width direction on the second lens array, in comparison with a case where respective small lenses in the first lens array are aligned in four or more columns with the illumination optical axis in between.

(3) For the projector set forth in (2), it is preferable that the illumination device includes a polarization conversion element to convert the illumination light to a polarized light, and the polarization conversion element formed of two sets of polarization conversion prism units, one set being disposed on either side with the illumination optical axis in between.

When configured in this manner, it is possible to convert an illumination light to a polarized light having one polarization axis due to the function of the polarization conversion element. Hence, the exemplary embodiment is suitable in a case where an electro-optic modulation device of a type using a polarized light, such as a liquid crystal display, is used as the electro-optic modulation device.

In this case, because respective small lenses in the first lens array are aligned in two columns with the illumination optical axis in between in the projector set forth in (2), it is preferable to use a polarization conversion element formed of two sets of polarization conversion prism units, one set being disposed on either side with the illumination optical axis in between.

When configured in this manner, only partial lights in one column are allowed to pass through one of both sides with the illumination optical axis in between, and a degree of freedom in disposing the polarization conversion prism unit in the polarization conversion element can be thus increased in comparison with a case where respective small lenses in the first lens array are aligned in four or more columns with the illumination optical axis in between. This eliminates the need to decenter respective small lenses in the first lens array and the second lens array, which can in turn suppress effectively deterioration of the optical characteristics and a cost increase.

(4) For the projector set forth in (3), it is preferable that the polarization conversion prism unit includes a polarization separation mirror that, of two polarization components contained in the illumination light, transmits one polarization component intact and reflects the other polarization component toward the illumination optical axis.

In the projector set forth in (3), only one set of the polarization conversion prism unit is disposed on one of both sides with the illumination optical axis in between; moreover, only partial lights in one column are allowed to pass through one side. This enables the other polarization component to be folded toward the illumination optical axis (inward) on the polarization separation mirror. It is thus possible to reduce the polarization conversion element in size in the polarization separating direction (normally, in the width direction) in comparison with a case where the other polarization component is reflected to the opposite side (outward) of the illumination optical axis on the polarization separation mirror. The parallelism in the width direction of an illumination light to irradiate the electro-optic modulation device can be thus improved, which can in turn further enhance the image quality of the projector.

(5) For the projector set forth in any of (1) through (4), it is preferable that a color separation system to separate the illumination light from the illumination device into plural color lights is further provided between the illumination device and the electro-optic modulation device, and plural electro-optic modulation devices are provided as the electro-optic modulation device to modulate the plural color lights from the color separation system according to image information corresponding to respective color lights.

When configured in this manner, a projector, with which efficiency of light utilization will not be reduced markedly even when configured to enable high-quality moving pictures to be displayed smoothly, can serve as a full-color projector (for example, triple-plate type) with an excellent image quality.

(6) For the projector set forth in (5), it is preferable that the scanning device includes a rotating prism having a rotational axis perpendicular to the illumination optical axis and disposed nearly at a conjugate position with the electro-optic modulation devices between the illumination device and the color separation system, and the rotating prism is configured to cause a light irradiated region and a light non-irradiated region to be scrolled successively on each of the electro-optic modulation devices in sync with the screen writing frequency of the electro-optic modulation devices through its own rotations.

When configured in this manner, a light irradiated region and a light non-irradiated region can also be scrolled smoothly in the image forming region in each of the electro-optic modulation devices in the full-color projector.

(7) For the projector set forth in (5), it is preferable that the scanning device includes a galvanometer mirror disposed between the illumination device and the color separation system, and the galvanometer mirror is configured to cause a light irradiated region and a light non-irradiated region to be scrolled on each of the electro-optic modulation devices in sync with the screen writing frequency of the electro-optic modulation devices through its own oscillations.

When configured in this manner, a light irradiated region and a light non-irradiated region can also be scrolled smoothly in the image forming region in each of the electro-optic modulation devices in the full-color projector.

(8) For the projector set forth in (5), it is preferable that the scanning device includes a polygonal mirror disposed between the illumination device and the color separation system, and the polygonal mirror is configured to cause a light irradiated region and a light non-irradiated region to be scrolled successively on each of the electro-optic modulation devices in sync with the screen writing frequency of the electro-optic modulation devices through its own rotations.

When configured in this manner, a light irradiated region and a light non-irradiated region can be also scrolled smoothly in the image forming region in each of the electro-optic modulation devices in the full-color projector.

(9) For the projector set forth in any of (1) through (8), it is preferable that the light source is a light source including an ellipsoidal reflector, an arc tube having a luminescent center in close proximity to a first focal point of the ellipsoidal reflector, and a parallelizing lens, or a light source including a parabolic reflector, and an arc tube having a luminescent center in close proximity to a focal point of the parabolic reflector.

When configured in this manner, in the former case, it is possible to achieve an optical device more compact than a light source using a parabolic reflector. In the latter case, because a substantially parallel illumination light can be obtained without having to use the parallelizing lens, it is possible to achieve an optical device having fewer components than a light source using an ellipsoidal reflector that needs a parallelizing lens.

(10) For the projector set forth in (9), it is preferable that the arc tube is provided with a reflecting device to reflect a light, emitted from the arc tube toward the illuminated region, to the ellipsoidal reflector or the parabolic reflector.

When configured in this manner, a light emitted from the arc tube toward the illuminated region is reflected to the ellipsoidal reflector or the parabolic reflector. This makes it unnecessary to set the size of the ellipsoidal reflector or the parabolic reflector to a size large enough to cover the end portion on the illuminated region side of the arc tube. The ellipsoidal reflector or the parabolic reflector can thus be reduced in size, which can in turn reduce the projector in size. This also means that the size of the respective lens arrays, the size of the polarization conversion element, the size of the superimposing lens, the size of the color separation system, etc. can be reduced further. The projector, therefore, can be reduced further in size.

### BRIEF DESCRIPTION OF THE DRAWINGS

FIGS. 1A and 1B are schematics that describe a projector according to a first exemplary embodiment;

FIGS. 2A-2C are schematics that describe the structure of a first lens array in an exemplary embodiment;

FIG. 3 is a schematic that describes a relation among the first lens array, a second lens array, and a polarization conversion element in an exemplary embodiment;

FIGS. 4A and 4B are schematics showing light intensity distributions of an illumination light in an exemplary embodiment;

FIGS. 5A-5C are schematics showing light intensity distributions of an illumination light on a liquid crystal display in an exemplary embodiment;

FIGS. 6A-6C are schematics showing a relation of rotations of a rotating prism and an illumination state on the liquid crystal display in an exemplary embodiment;

FIGS. 7A and 7B are schematics that describe a projector according to a second exemplary embodiment;

FIGS. 8A-8C are schematics that describe the structure of the first lens array in an exemplary embodiment;

FIG. 9 is a schematic that describes a relation among the first lens array, the second lens array, and the polarization conversion element in an exemplary embodiment;

FIGS. 10A and 10B are schematics that describe a projector according to a third exemplary embodiment;

FIGS. 11A and 11B are schematics that describe a projector according to a fourth exemplary embodiment;

FIGS. 12A and 12B are schematics that describe a projector according to a fifth exemplary embodiment;

FIGS. 13A-13C are schematics that describe a projector of the related art; and

FIGS. 14A-14C are schematics that describe another projector of the related art.

### DETAILED DESCRIPTION OF EMBODIMENTS

A projector in an exemplary embodiment of the present invention will now be described as shown in the drawings.

### First Exemplary Embodiment

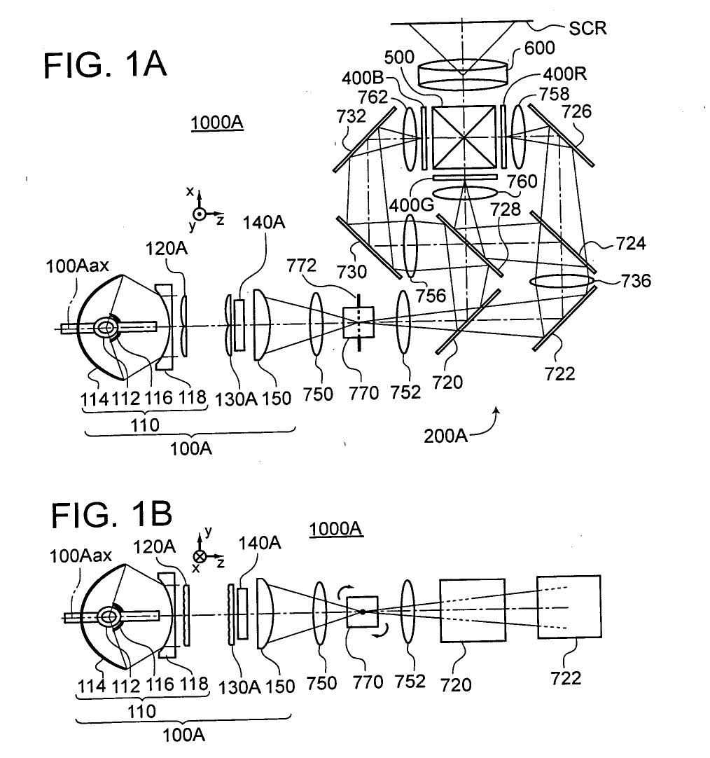

FIGS. 1A and 1B are schematics that describe a projector according to a first exemplary embodiment of the invention. FIG. 1(A) is a plan view and FIG. 1(B) is a side view.

As are shown in FIG. 1(A) and FIG. 1(B), a projector 1000A according to the first exemplary embodiment is a projector including: an illumination device 100A; a color separation system 200A to separate an illumination light from the illumination device 100A into three color lights of red, green and blue; three liquid crystal displays 400R, 400G, and 400B serving as electro-optic modulation devices to modulate three color lights, separated in the color separation system 200A, according to image information; a cross dichroic prism 500 to combine color lights respectively modulated in these three liquid crystal displays 400R, 400G, and 400B; and a projection system 600 to project lights combined in the cross dichroic prism 500 onto a projection surface, such as a screen SCR.

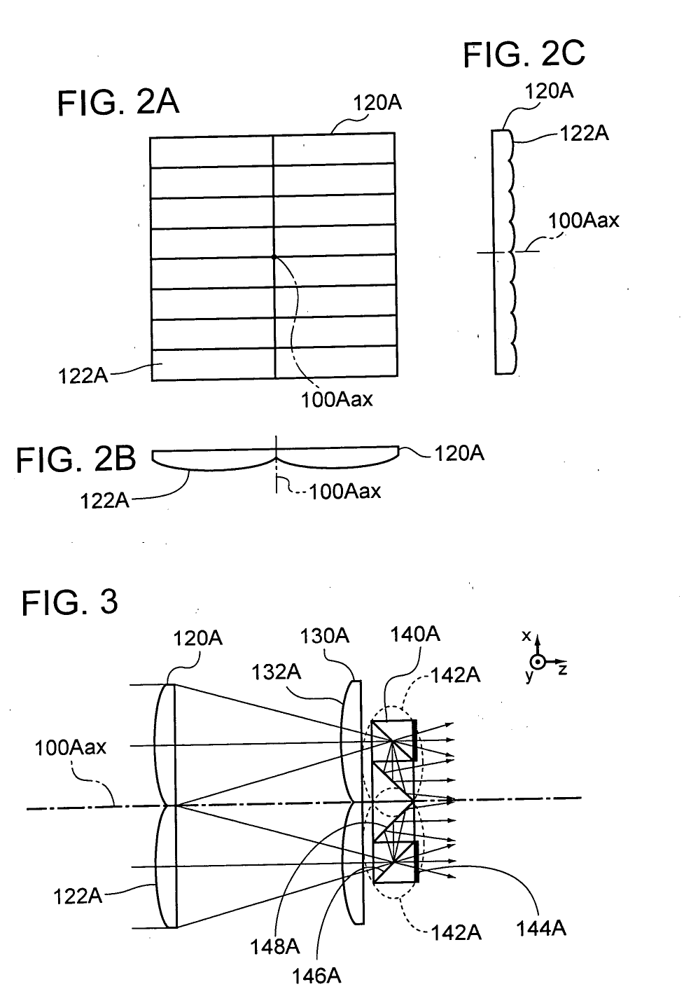

The illumination device 100A includes: a light source 110 to emit a substantially parallel illumination light toward an illuminated region; a first lens array 120A having plural small lenses 122A (see FIGS. 2A-3) to divide an illumination light from the light source 110 into plural partial lights; a second lens array 130A having plural small lenses 132A (see FIG. 3) respectively corresponding to the plural small lenses 122A in the first lens array 120A; a polarization conversion element 140A to convert an illumination light into a polarized light; and a superimposing lens 150 to superimpose respective partial lights from the polarization conversion element 140A onto the illuminated region.

The light source 110 includes an ellipsoidal reflector 114; an arc tube 112 having its luminescent center in close proximity to a first focal point of the ellipsoidal reflector 114; and a parallelizing lens 118 to convert condensed lights from the ellipsoidal reflector 114 into substantially parallel lights. The arc tube 112 is provided with a sub-mirror 116 serving as a reflecting device to reflect a light, emitted from the arc tube 112 toward the illuminated region, to the ellipsoidal reflector 114.

An equi-optical path system, in which optical path lengths from the illumination device 100A to the respective liquid crystal displays 400R, 400G, and 400B are all equal, is used as the color separation system 200A.

As the liquid crystal displays 400R, 400G, and 400B, wide-vision liquid crystal displays of a planar shape defined as “a rectangle having a ratio, a length dimension along the y-axis direction: a width dimension along the x-axis direction=9:16” are used.

The projector 1000A according to the first exemplary embodiment has the configuration of the first lens array 120A and the use of a scanning device including a rotating prism 770.

To be more specific, each small lens 122A in the first lens array 120A is of a planar shape compressed in the length direction to change an illumination light from the illumination device 100A to an illumination light having a profile such that the illumination light illuminates the entire image forming region as to the width direction along the x-axis direction of the image forming region in each of the liquid crystal displays 400R, 400G and 400B and a part of the image forming region as to the length direction along the y-axis direction.

The rotating prism 770 is disposed nearly at a conjugate position with the liquid crystal displays 400R, 400G, and 400B between the illumination device 100A and the color separation system 200A, and is furnished with a function of scanning an illumination light across the image forming region along the y-axis direction in sync with a screen writing frequency of the liquid crystal displays 400R, 400G, and 400B by rotating about the rotational axis 772 perpendicular to the illumination optical axis 100Aax.

The projector 1000A according to the first exemplary embodiment is thus able to scan an illumination light, having a profile such that illuminates the entire image forming region as to the width direction along the x-axis direction of the image forming region in each of the liquid crystal displays 400R, 400G and 400B and a part of the image forming region as to the length direction along the y-axis direction (that is, a profile compressed in the length direction along the y-axis direction), across the image forming region along the y-axis direction in sync with the screen writing frequency of the liquid crystal displays 400R, 400G, and 400B. Hence, a light irradiated region and a light non-irradiated region are scrolled successively in turn on the image forming region in each of the liquid crystal displays 400R, 400G, and 400B. As a result, a tailing phenomenon is eased, and it serves as a projector capable of displaying high-quality moving pictures smoothly.

In addition, the projector 1000A according to the first exemplary embodiment achieves an illumination light having the profile compressed in the length direction as described above by using, as the first lens array 120A, a lens array in which respective small lenses 122A (see FIGS. 2A-2C) are of a planar shape compressed in the length direction. Hence, in contrast to using the optical shutters, it is possible to guide an illumination light from the light source 110 to the image forming regions in the liquid crystal displays 400R, 400G, and 400B while eliminating wastes, which can in turn prevent efficiency of light utilization from being reduced markedly.

The projector 1000A according to the first exemplary embodiment thus serves as a projector with which efficiency of light utilization will not be reduced markedly even when configured to enable high-quality moving pictures to be displayed smoothly.

The first lens array 120A and the rotating prism 770 in the projector 1000A according to the first exemplary embodiment will now be described in detail.

1. First Lens Array

FIGS. 2A-2C are schematics used to describe the structure of the first lens array. FIG. 2(A) is a view in a direction along the z-axis direction. FIG. 2(B) is a view in a direction along the y-axis direction. FIG. 2(C) is a view in a direction along the x-axis direction.

As is shown in FIG. 2(A), the first lens array 120A is of a planar shape defined as “a rectangle having a ratio, a length dimension along the y-axis direction: a width direction along the x-axis direction=1:4”. The first lens array 120A is therefore able to change an illumination light from the illumination device 100A to an illumination light having a profile such that the illumination light illuminates the entire image forming region as to the width direction along the x-axis direction of the image forming region in each of the liquid crystal displays 400R, 400G and 400B and a part (about half) of the image forming region as to the length direction along the y-axis direction.

FIG. 3 describes a relation among the first lens array, the second lens array, and the polarization conversion element.

The first lens array 120A has plural small lenses 122A aligned in two columns (eight rows) with the illumination optical axis 100Aax in between.

The second lens array 130A includes plural small lenses 132A aligned in two columns (eight rows), which are, respectively, in correspondence with the plural small lenses 122A in the first lens array 120A.

The polarization conversion element 140A includes two sets of polarization conversion prism units 142A, one set being disposed on either side with the illumination optical axis 100Aax in between. The polarization conversion prism unit 142A includes a polarization separation surface 146A and a reflection surface 148A that, of two polarization components contained in the illumination light, transmit one polarization component (for example, S-polarized light) intact and reflect the other polarization component (for example, P-polarized light) toward the illumination optical axis 100Aax.

A retardation film (λ/2 plate) 144A is provided on the S-polarized light transmitting surface of each polarization conversion prism unit 142A, and polarized lights in the illumination light emitted from the polarization conversion element 140A are all converted to P-polarized lights.

In the projector 1000A according to the first exemplary embodiment, the respective small lenses 122A in the first lens array 120A are aligned in two columns with the illumination optical axis 100Aax in between. Respective partial lights from the first lens array 120A are thus aligned in one column with the illumination optical axis 100Aax in between on the second lens array 130A. It is thus possible to effectively suppress a reduction in efficiency of light utilization caused when respective partial lights are separated unsatisfactorily in the width direction on the second lens array 130A (in comparison with a case where respective small lenses in the first lens array are aligned in four or more columns with the illumination optical axis in between).

In the projector 1000A according to the first exemplary embodiment, the respective small lenses 122A in the first lens array 120A are aligned in two columns with the illumination optical axis 100Aax in between. In order to correspond to this configuration, a component including two sets of polarization conversion prism units 142A, one being disposed on either side with the illumination optical axis 100Aax in between, is used as the polarization conversion element 140A.

Hence, with the projector 1000A according to the first exemplary embodiment, only partial lights in one column are allowed to pass through one of the both sides with the illumination optical axis 100Aax in between, and a degree of freedom in disposing the polarization conversion prism unit 142A in the polarization conversion element 140A can be thus increased (in comparison with a case where respective small lenses in the first lens array are aligned in four or more columns with the illumination optical axis in between). This eliminates the need to decenter respective small lenses 122A and 132A in the first lens array 120A and the second lens array 130A, respectively, which can in turn effectively suppress deterioration of the optical characteristics and a cost increase.

In the projector 1000A according to the first exemplary embodiment, only one set of the polarization conversion prism unit 142A is disposed on one of the both sides with the illumination optical axis 100Aax in between; moreover, only partial lights in one column are allowed to pass through one side. This enables the other polarization component (P-polarized light) to be folded toward the illumination optical axis 100Aax (inward) on the polarization separation surface 146A. It is thus possible to reduce the polarization conversion element 140A in size in the polarization separating direction (width direction) (in comparison with a case where the other polarization component (P-polarized light) is reflected to the opposite side (outward) of the illumination optical axis 100Aax on the polarization separation surface 146A). The parallelism in the width direction of an illumination light to irradiate the liquid crystal displays 400R, 400G, and 400B can be thus improved, which can in turn further enhance the image quality of the projector.

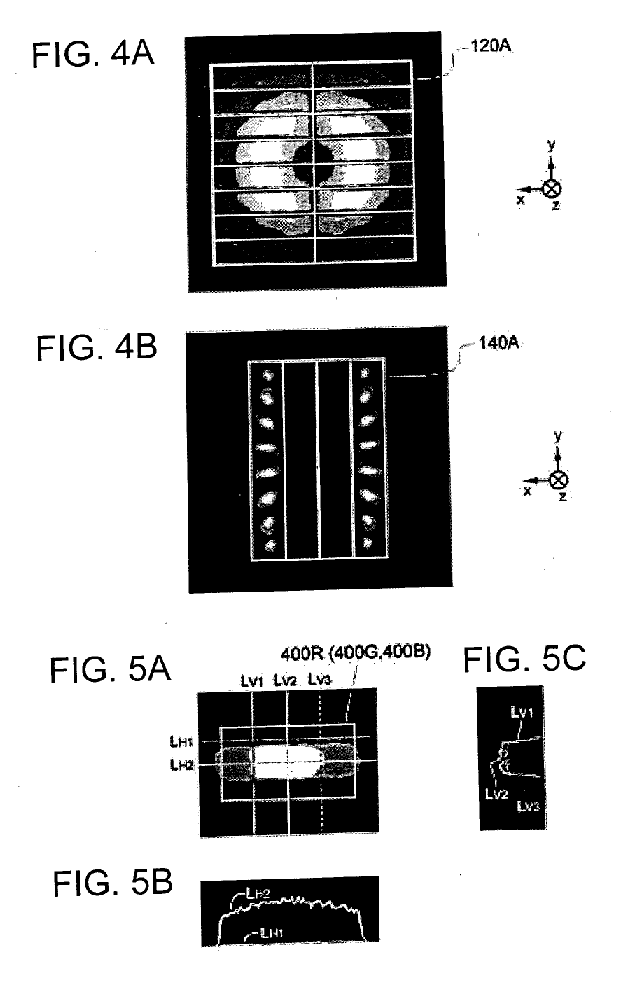

FIGS. 4A and 4B are schematics showing light intensity distributions of an illumination light. FIG. 4(A) is a view showing light intensity distributions of an illumination light on a light incident-surface of the first lens array. FIG. 4(B) is a view showing light intensity distributions of an illumination light on a light incident-surface of the polarization conversion element 140A.

An illumination light distributed across the entire first lens array 120A on the light incident-surface of the first lens array 120A, as is shown in FIG. 4(A), is guided onto the polarization separation surface 146A of each polarization conversion prism unit 142A in the polarization conversion element 140A in a satisfactory manner, as shown in FIG. 4(B). This indicates that no light is wasted.

FIGS. 5A-5C are schematics showing light intensity distributions of an illumination light on the liquid crystal display. FIG. 5(A) is a view showing light intensity distributions of an illumination light on the liquid crystal display in the form of a contour. FIG. 5(B) is a view showing a graph of light intensity distributions of an illumination light on virtual lines L_{H1} and L_{H2} in FIG. 5(A). FIG. 5(C) is a view showing graph of light intensity distributions of an illumination light on virtual lines L_{V1}, L_{V2}, and L_{V3} in FIG. 5(A).

As are shown in FIG. 5(A) through FIG. 5(C), an illumination light having relatively inhomogeneous light intensity distributions in the first lens array 120A (see FIG. 4(A)) is converted to an illumination light having relatively homogenous light intensity distributions in the liquid crystal displays 400R, 400G, and 400B. The substantially circular profile of an illumination light (see FIG. 4(A)) is converted to “a rectangle having a ratio, a length dimension along the y-axis direction: a width dimension along the x-axis direction=1:4”. This enables an illumination light, having a profile such that illuminates the entire image forming region as to the width direction along the x-axis direction and a part of the image forming region as to the length direction along the y-axis direction (that is, a profile compressed in the length direction along the y-axis direction), to be irradiated on the image forming regions in the liquid crystal displays 400R, 400G and 400B.

2. Rotating Prism

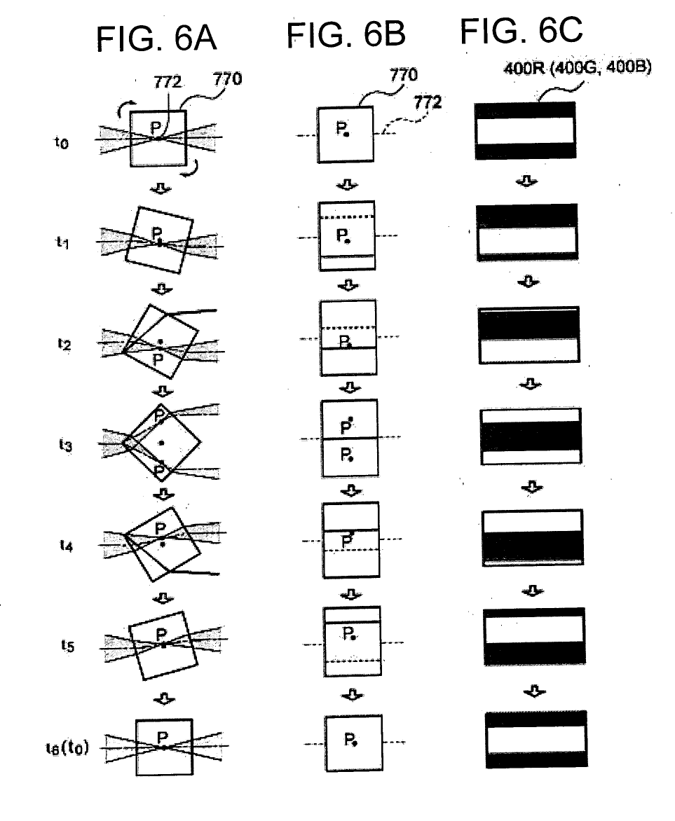

FIGS. 6A-6C are schematics showing a relation of rotations of the rotating prism and an illumination state on the liquid crystal display. FIG. 6(A) is a cross section of the rotating prism when viewed along the rotational axis. FIG. 6(B) is a view of the rotating prism when viewed along the illumination optical axis. FIG. 6(C) is a view showing an irradiation state of an illumination light on the image forming region in the liquid crystal display.

FIG. 6(A) and FIG. 6(B) show a manner in which an image P at the virtual central point of the first lens array 120A on the illumination optical axis 100Aax is scrolled in a vertical direction about the rotational axis 772 of the rotating prism 770 in association with rotations of the rotating prism 770. Hence, as is shown in FIG. 6(C), when the rotating prism 770 rotates, a light irradiated region and a light non-irradiated region are scrolled successively in turn on the image forming regions in the liquid crystal displays 400R, 400G, and 400B.

In the projector 1000A according to the first exemplary embodiment, the light source 110, by including the ellipsoidal reflector 114, the arc tube 112 having its luminescent center in close proximity to the first focal point of the ellipsoidal reflector 114, and the parallelizing lens 118, can achieve an optical device more compact than a light source using a parabolic reflector.

In the projector 1000A according to the first exemplary embodiment, as are shown in FIG. 1(A) and FIG. 1(B), the arc tube 112 is provided with the sub-mirror 116 as reflecting means for reflecting a light, emitted from the arc tube 112 toward the illuminated region, to the ellipsoidal reflector 114.

A light emitted from the arc tube 112 toward the illuminated region is thus reflected to the ellipsoidal reflector 114. This makes it unnecessary to set the size of the ellipsoidal reflector 114 to a size large enough to cover the end portion on the illuminated region side of the arc tube 112. The ellipsoidal reflector 114 can thus be reduced in size, which can in turn reduce the projector 1000A in size. This also means that the size of the respective lens arrays 120A and 130A, the size of the polarization conversion element 140A, the size of the superimposing lens 150, the size of the color separation system 200A, etc. can be reduced further. The projector 1000A, therefore, can be reduced further in size.

### Second Exemplary Embodiment

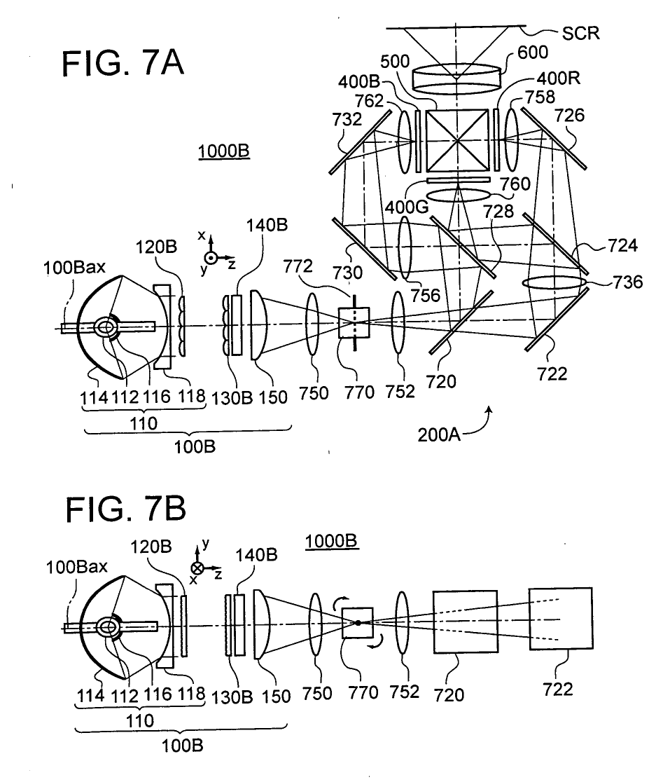

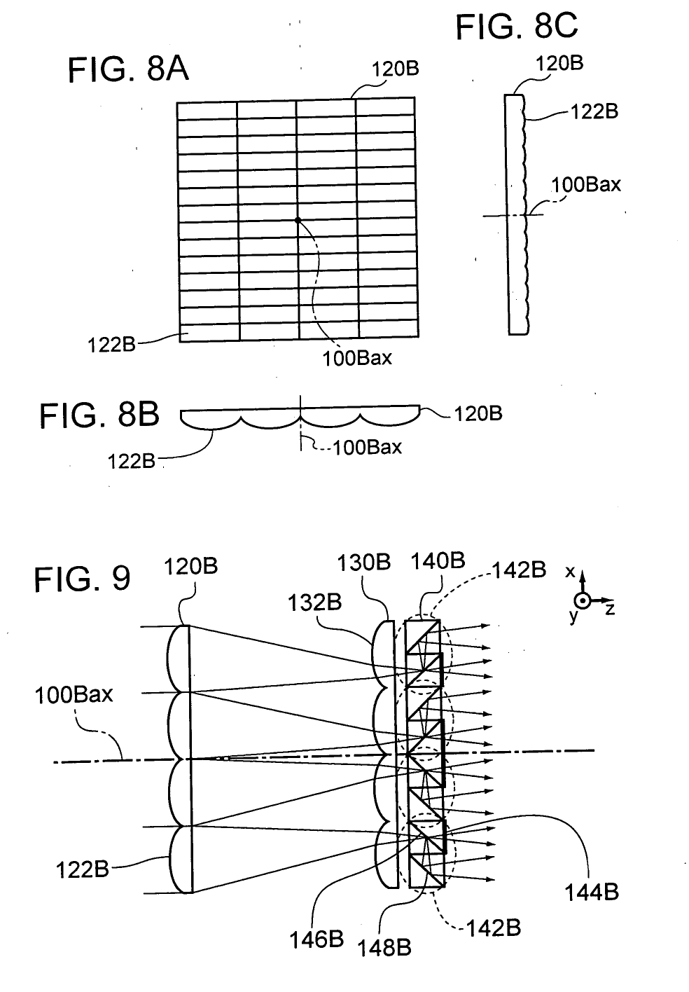

FIGS. 7A and 7B are schematics used to describe a projector according to a second exemplary embodiment of the invention. FIG. 7(A) is a plan view and FIG. 7(B) is a side view. FIGS. 8A-8C are schematics used to describe the structure of the first lens array. FIG. 8(A) is a view in a direction along the z axis used as the illumination optical axis. FIG. 8(B) is a view in a direction along the y-axis direction. FIG. 8(C) is a view in a direction along the x-axis direction.

A projector 1000B according to the second exemplary embodiment is different from the projector 1000A according to the first exemplary embodiment in the configurations of the first lens array, the second lens array, and the polarization conversion element.

As shown in FIG. 8(A), a first lens array 120B is of a planar shape defined as “a rectangle having a ratio, a length dimension along the y-axis direction: a width dimension along the x-axis direction=9:32”. The first lens array 120B is thus able to change an illumination light from an illumination device 100B into an illumination light having a profile such that illuminates the entire image forming region as to the width direction along the x-axis direction of the image forming region in each of the liquid crystal displays 400R, 400G, and 400B, and a part (about half) of the image forming region as to the length direction along the y-axis direction.

FIG. 9 is a schematic used to describe a relation among the first lens array, the second lens array, and the polarization conversion element.

The first lens array 120B includes a plurality of small lenses 122B aligned in four columns (14 rows) with an illumination optical axis 100Bax in between.

A second lens array 130B includes a plurality of small lenses 132B aligned in four columns (14 rows), which are, respectively, in correspondence with the plurality of small lenses 122B in the first lens array 120B.

Each of the plurality of small lenses 122B in the first lens array 120B includes a decentered lens for a partial light from each small lens 122B to pass through the corresponding small lens 132B.

A polarization conversion element 140B includes four sets of polarization conversion prism units 142B, two sets being disposed on either side with the illumination optical axis 100Bax in between. The polarization conversion prism unit 142B includes a polarization separation surface 146B and a reflection surface 148B that, of two polarization components contained in an illumination light, transmits one polarization component (for example, S-polarized light) intact and reflects the other polarization component (for example, P-polarized light) to the opposite side of the illumination optical axis 100Bax.

A retardation film (λ/2 plate) 144B is provided on the S-polarized light transmitting surface of each polarization conversion prism unit 142B, and polarized lights in the illumination light emitted from the polarization conversion element 140B are all converted to P-polarized lights.

As has been described, the projector 1000B according to the second exemplary embodiment is different from the projector 1000A according to the first exemplary embodiment in the configurations of the first lens array, the second lens array, and the polarization conversion element. However, as with the projector 1000A according to the first exemplary embodiment, each small lens 122B in the first lens array 120B is of a planar shape compressed in the length direction to change an illumination light from the illumination device 100B to an illumination light having a profile such that the illumination light illuminates the entire image forming region as to the width direction along the x-axis direction in the image forming region in each of the liquid crystal devices 400R, 400G, and 400B and a part of the image forming region as to the length direction along the y-axis direction.

Also, the rotating prism 770 is disposed nearly at a conjugate position with the liquid crystal displays 400R, 400G, and 400B between the illumination device 100B and the color separation system 200A, and is furnished with a function of scanning an illumination light across the image forming region along the y-axis direction in sync with a screen writing frequency of the liquid crystal displays 400R, 400G, and 400B by rotating about the rotational axis 772 perpendicular to the illumination optical axis 100Bax.

The projector 1000B according to the second exemplary embodiment is thus able to scan an illumination light, having a profile such that illuminates the entire image forming region as to the width direction along the x-axis direction of the image forming region in each of the liquid crystal displays 400R, 400G and 400B and a part of the image forming region as to the length direction along the y-axis direction (that is, a profile compressed in the length direction), across the image forming region along the y-axis direction in sync with the screen writing frequency of the liquid crystal displays 400R, 400G, and 400B. Hence, a light irradiated region and a light non-irradiated region are scrolled successively in turn on the image forming regions in the liquid crystal displays 400R, 400G, and 400B. As a result, a tailing phenomenon is eased, and it serves as a projector capable of displaying high-quality moving pictures smoothly.

In addition, the projector 1000B according to the second exemplary embodiment achieves an illumination light having the profile compressed in the length direction as described above by using, as the first lens array 120B, a lens array in which respective small lenses 122B are of a planar shape compressed in the length direction. Hence, as with the projector 1000A according to the first exemplary embodiment, it is possible to guide an illumination light from the light source 110 to the image forming regions in the liquid crystal displays 400R, 400G, and 400B while eliminating wastes, which can in turn prevent efficiency of light utilization from being reduced markedly.

The projector 1000B according to the second exemplary embodiment thus serves as a projector with which efficiency of light utilization will not be reduced markedly even when configured to enable high-quality moving pictures to be displayed smoothly.

### Third Exemplary Embodiment

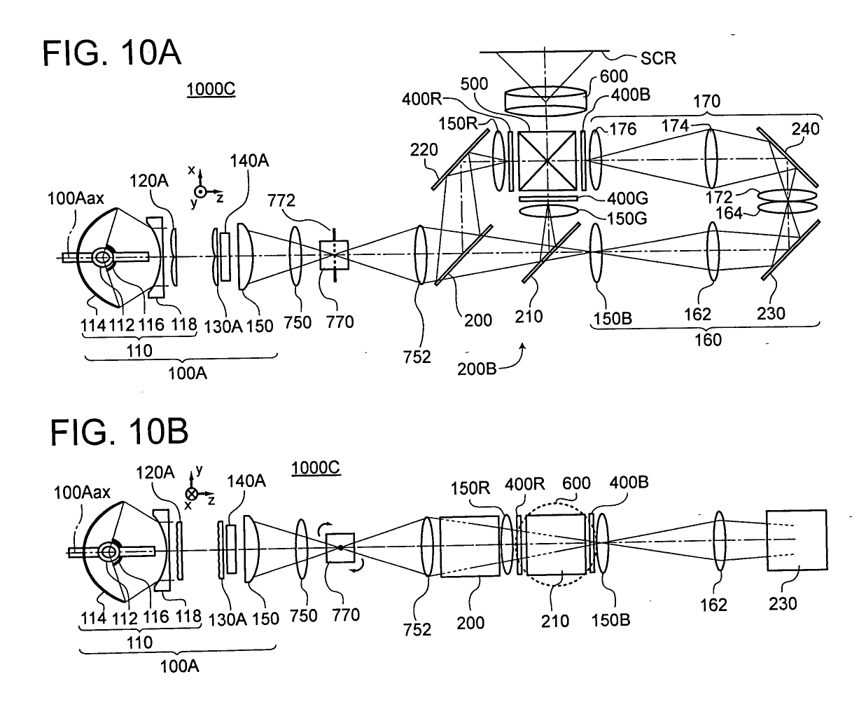

FIGS. 10A and 10B are schematics used to describe a projector according to a third exemplary embodiment of the invention. FIG. 10(A) is a plan view and FIG. 10(B) is a side view.

As shown in FIG. 10(A), a projector 1000C according to the third exemplary embodiment is different from the projector 1000A according to the first exemplary embodiment in configuration of the color separation system.

To be more specific, a color separation system 200B in the projector 1000C according to the third exemplary embodiment uses a double-relay system in making directions along which a light irradiated region and a light non-irradiated region are scrolled on each of the liquid crystal displays 400R, 400G, and 400B all the same.

As has been described, the projector 1000C according to the third exemplary embodiment is different from the projector 1000A according to the first exemplary embodiment in configuration of the color separation system. However, as with the projector 1000A according to the first exemplary embodiment, each small lens 122A in the first lens array 120A is of a planar shape compressed in the length direction to change an illumination light from the illumination device 100A to an illumination light having a profile such that the illumination light illuminates the entire image forming region as to the width direction along the x-axis direction of the image forming region in each of the liquid crystal devices 400R, 400G, and 400B and a part of the image forming region as to the length direction along the y-axis direction.

Also, the rotating prism 770 is disposed nearly at a conjugate position with the liquid crystal displays 400R, 400G, and 400B between the illumination device 100A and the color separation system 200B, and is furnished with a function of scanning an illumination light across the image forming region along the y-axis direction in sync with a screen writing frequency of the liquid crystal displays 400R, 400G, and 400B by rotating about the rotational axis 772 perpendicular to the illumination optical axis 100Aax.

Hence, in the projector 1000C according to the third exemplary embodiment, a light irradiated region and a light non-irradiated region are scrolled successively in turn on the image forming regions in the liquid crystal displays 400R, 400G, and 400B. As a result, a tailing phenomenon is eased, and it serves as a projector capable of displaying high-quality moving pictures smoothly.

In addition, the projector 1000C according to the third exemplary embodiment achieves an illumination light having the profile compressed in the length direction as described above by using, as the first lens array 120A, a lens array in which respective small lenses 122A are of a planar shape compressed in the length direction. Hence, as with the projector 1000A according to the first exemplary embodiment, it is possible to guide an illumination light from the light source 110 to the image forming regions in the liquid crystal displays 400R, 400G, and 400B while eliminating wastes, which can in turn prevent efficiency of light utilization from being reduced markedly.

The projector 1000C according to the third exemplary embodiment thus serves as a projector with which efficiency of light utilization will not be reduced markedly even when configured to enable high-quality moving pictures to be displayed smoothly.

### Fourth Exemplary Embodiment

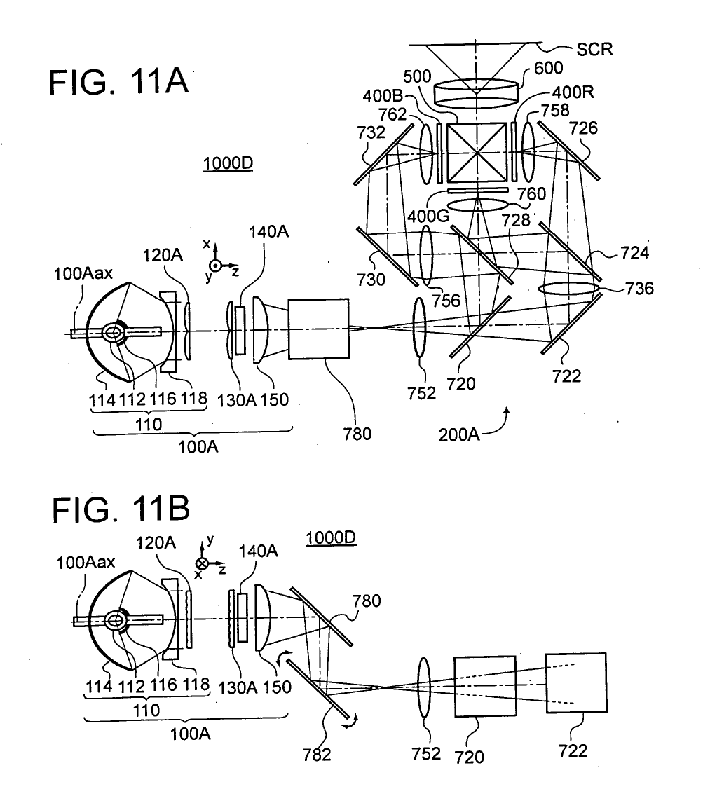

FIGS. 11A and 11B are schematics used to describe a projector according to a fourth exemplary embodiment of the invention. FIG. 11(A) is a plan view and FIG. 11(B) is a side view.

As shown in FIG. 11(B), a projector 1000D according to the fourth exemplary embodiment is different from the projectors 1000A through 1000C according to the first through third exemplary embodiments in configuration of the scanning device.

To be more specific, the scanning device used in the projector 1000D, according to the fourth exemplary embodiment, is a galvanometer mirror 782 configured to cause a light irradiated region and a light non-irradiated region to be scrolled on the liquid crystal displays 400R, 400G, and 400B in sync with a screen writing frequency of the liquid crystal displays 400R, 400G, and 400B through its own oscillations.

As has been described, the projector 1000D according to the fourth exemplary embodiment is different from the projectors 1000A through 1000C according to the first through third exemplary embodiments in configuration of the scanning device. However, as with the projectors 1000A through 1000C according to the first through third exemplary embodiments, each small lens 122A in the first lens array 120A is of a planar shape compressed in the length direction to change an illumination light from the illumination device 100A to an illumination light having a profile such that illuminates the entire image forming region as to the width direction along the x-axis direction in the image forming region in each of the liquid crystal devices 400R, 400G, and 400B and a part of the image forming region as to the length direction along the y-axis direction.

Also, the galvanometer 782 is furnished with a function of scanning an illumination light across the image forming region along the y-axis direction in sync with a screen writing frequency of the liquid crystal displays 400R, 400G, and 400B through its own oscillations.

Hence, in the projector 1000D according to the fourth exemplary embodiment, a light irradiated region and a light non-irradiated region are scrolled successively in turn on the image forming regions in the liquid crystal displays 400R, 400G, and 400B. As a result, a tailing phenomenon is eased, and it serves as a projector capable of displaying high-quality moving pictures smoothly.

In addition, the projector 1000D according to the fourth exemplary embodiment achieves an illumination light having the profile compressed in the length direction as described above by using, as the first lens array 120A, a lens array in which respective small lenses 122A are of a planar shape compressed in the length direction. Hence, as with the projectors 1000A through 1000C according to the first through third exemplary embodiments, it is possible to guide an illumination light from the light source 110 to the image forming regions in the liquid crystal displays 400R, 400G, and 400B while eliminating wastes, which can in turn prevent efficiency of light utilization from being reduced markedly.

The projector 1000D according to the fourth exemplary embodiment thus serves as a projector with which efficiency of light utilization will not be reduced markedly even when configured to enable high-quality moving pictures to be displayed smoothly.

### Fifth Exemplary Embodiment

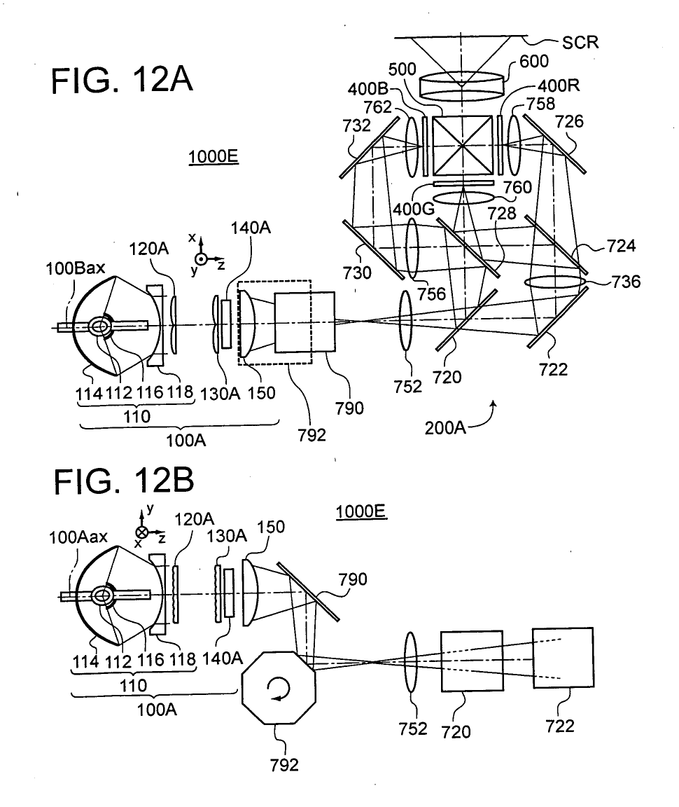

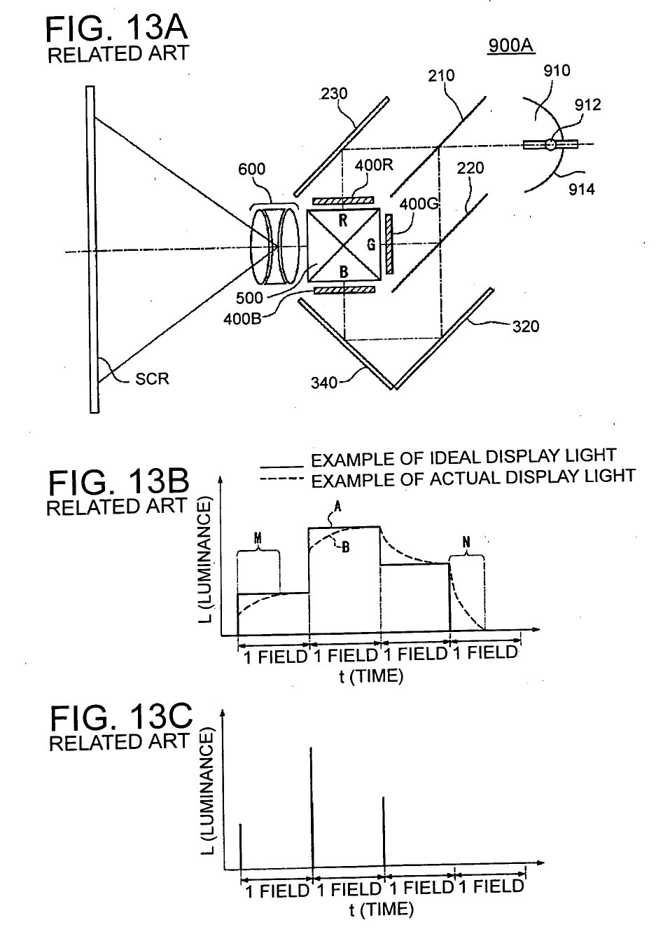

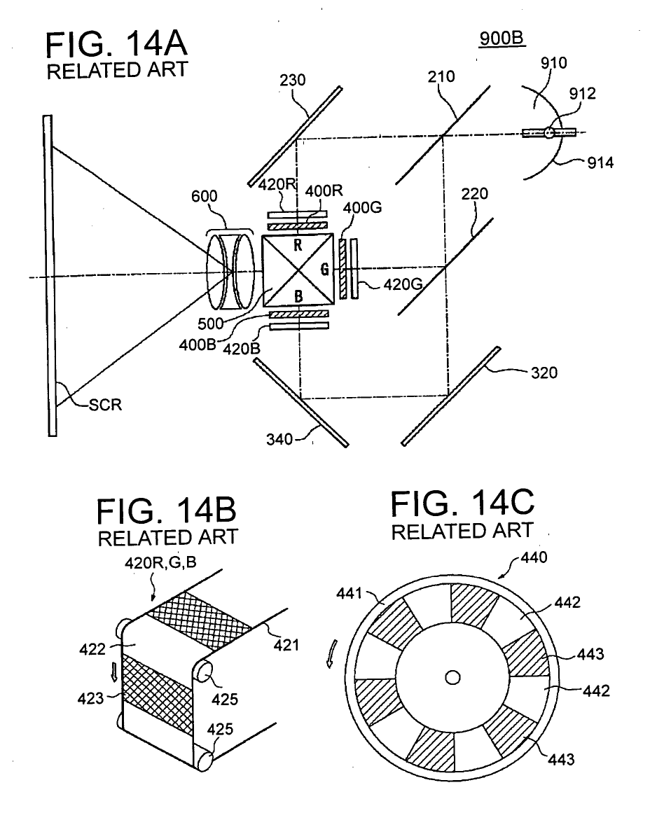

FIGS. 12A and 12B are schematics used to describe a projector according to a fifth exemplary embodiment of the invention. FIG. 12(A) is a plan view and FIG. 12(B) is a side view.

As shown in FIG. 12(B), a projector 1000E according to the fifth exemplary embodiment is different from the projectors 1000A through 1000C according to the first through third exemplary embodiments in configuration of the scanning device.

To be more specific, the scanning device used in the projector 1000E according to the fifth exemplary embodiment is a polygonal mirror 792 configured to cause a light irradiated region and a light non-irradiated region to be scrolled on the liquid crystal displays 400R, 400G, and 400B in sync with a screen writing frequency of the liquid crystal displays 400R, 400G, and 400B through its own rotations.

As has been described, the projector 1000E according to the fifth exemplary embodiment is different from the projectors 1000A through 1000C according to the first through third exemplary embodiments in configuration of the scanning device. However, as with the projector 1000A through 1000C according to the first through third exemplary embodiments, each small lens 122A in the first lens array 120A is of a planar shape compressed in the length direction to change an illumination light from the illumination device 100A to an illumination light having a profile such that the illumination light illuminates the entire image forming region as to the width direction along the x-axis direction in the image forming region in each of the liquid crystal devices 400R, 400G, and 400B and a part of the image forming region as to the length direction along the y-axis direction.

Also, the polygonal mirror 792 is furnished with a function of scanning an illumination light across the image forming region along the y-axis direction in sync with a screen writing frequency of the liquid crystal displays 400R, 400G, and 400B through its own rotations.

Hence, in the projector 1000E according to the fifth exemplary embodiment, a light irradiated region and a light non-irradiated region are scrolled successively to turn on the image forming regions in the liquid crystal displays 400R, 400G, and 400B. As a result, as with the projectors 1000A through 1000C according to the first through third exemplary embodiments, a tailing phenomenon is eased, and it serves as a projector capable of displaying high-quality moving pictures smoothly.

In addition, the projector 1000E according to the fifth exemplary embodiment achieves an illumination light having the profile compressed in the length direction as described above by using, as the first lens array 120A, a lens array in which respective small lenses 122A are of a planar shape compressed in the length direction. Hence, as with the projectors 1000A through 1000C according to the first through third exemplary embodiments, it is possible to guide an illumination light from the light source 110 to the image forming regions in the liquid crystal displays 400R, 400G, and 400B while eliminating wastes, which can in turn prevent efficiency of light utilization from being reduced markedly.

The projector 1000E according to the fifth exemplary embodiment thus serves as a projector with which efficiency of light utilization will not be reduced markedly even when configured to enable high-quality moving pictures to be displayed smoothly.

While the projector of the exemplary embodiments of the present invention has been described herein by way of various exemplary embodiments, the invention is not limited to the exemplary embodiments described above, and can be implemented otherwise in various manners without deviating from the scope of the invention. For instance, modifications as follows are possible.

(1) The projectors 1000A through 1000E in the exemplary embodiments described above may be transmission type projectors; however, the exemplary embodiments may also be applicable to a reflection type projector. The transmission type referred to herein is a transmission type in which electro-optic modulation devices serving as a light modulating device transmit lights like a transmission type liquid crystal display or the like. The reflection type referred to herein is a reflection type in which electro-optic modulation devices serving as light modulating devices reflect lights like a reflection type liquid crystal display. When the invention is applied to a reflection type projector, substantially the same advantages as those attained by the transmission type projector can be achieved.

(2) The projectors 1000A through 1000E according to the exemplary embodiments described above use liquid crystal displays as electro-optic modulation devices; however, the invention is not limited to this configuration. Any electro-optic modulation device that modulates an incident light according to image information is generally available, and a micro-mirror type light modulation device may be used. For example, a DMD (Digital Micro-mirror Device: a trademark of Texas Instruments) can be used as the micro-mirror type light modulation device.

(3) The projectors 1000A through 1000E according to the exemplary embodiments described above use the small lenses 122A or 122B in the first lens array 120A or 120B of a planar shape defined as “a rectangle having a ratio, a length dimension: a width direction=1:4” or “a rectangle having a ratio, a length dimension: a width direction=9:32”. However, the invention is not limited to this configuration, and for example, those of a planar shape defined as “a rectangle having a ratio, a length dimension: a width direction=3:8” can be also used suitably.

(4) The projectors 1000A through 1000E according to the exemplary embodiments above use a light source including the ellipsoidal reflector 114, the arc tube 112 having its luminescent center in close proximity to the first focal point of the ellipsoidal reflector 114, and the parallelizing lens 118, as the light source 110. The exemplary embodiments, however, are not limited to this configuration, and a light source having a parabolic reflector and an arc tube having its luminescent center in close proximity to the focal point of the parabolic reflector can also be used suitably.

1. A projector, comprising:
an illumination device including a light source to emit a substantially parallel illumination light toward an illuminated region, a first lens array having a plurality of small lenses to divide the illumination light from the light source into a plurality of partial lights, a second lens array having a plurality of small lenses respectively corresponding to the plurality of small lenses of the first lens array, and a superimposing lens to superimpose respective partial lights from the second lens array onto the illuminated region;
an electro-optic modulation device to modulate an illumination light from the illumination device according to image information, each of the plurality of small lenses in the first lens array being configured to change the illumination light from the illumination device to an illumination light having a profile such that the illumination light illuminates an entire image forming region to either one of length and width directions of the image forming region in the electro-optic modulation device and a part of the image forming region in the other direction, and is thereby of a planar shape compressed in the other direction;
a projection system to project a light modulated by the electro-optic modulation device; and
a scanning device to scan the illumination light across the image forming region along the other direction in sync with a screen writing frequency of the electro-optic modulation device further provided between the illumination device and the electro-optic modulation device.

2. The projector according to claim 1,
the respective plurality of small lenses in the first lens array being aligned in two columns with an illumination optical axis in between.

3. The projector according to claim 2,
the illumination device including a polarization conversion element to convert the illumination light to a polarized light; and
the polarization conversion element including two sets of polarization conversion prism units, one set being disposed on either side with the illumination optical axis in between.

4. The projector according to claim 3,
the polarization conversion prism unit including a polarization separation mirror that, of two polarization components contained in the illumination light, transmits one polarization component intact and reflects the other polarization component toward the illumination optical axis.

5. The projector according to claim 1, further comprising:
a color separation system, disposed between the illumination device and the electro-optic modulation device, to separate the illumination light from the illumination device into plural color lights,
the electro-optic modulation device including a plurality of electro-optic modulation devices to modulate the plural color lights from the color separation system according to image information corresponding to respective color lights.

6. The projector according to claim 5,
the scanning device including a rotating prism having a rotational axis perpendicular to the illumination optical axis and disposed nearly at a conjugate position with the electro-optic modulation devices between the illumination device and the color separation system; and
the rotating prism being configured to cause a light irradiated region and a light non-irradiated region to be scrolled successively on each of the electro-optic modulation devices in sync with the screen writing frequency of the electro-optic modulation devices through its own rotations.

7. The projector according to claim 5,
the scanning device including a galvanometer mirror disposed between the illumination device and the color separation system; and
the galvanometer mirror being configured to cause a light irradiated region and a light non-irradiated region to be scrolled on each of the electro-optic modulation devices in sync with the screen writing frequency of the electro-optic modulation devices through its own oscillations.

8. The projector according to claim 5,
the scanning device including a polygonal mirror disposed between the illumination device and the color separation system; and
the polygonal mirror being configured to cause a light irradiated region and a light non-irradiated region to be scrolled successively on each of the electro-optic modulation devices in sync with the screen writing frequency of the electro-optic modulation devices through its own rotations.

9. The projector according to claim 1,
the light source being a light source including an ellipsoidal reflector, an arc tube having a luminescent center in close proximity to a first focal point of the ellipsoidal reflector, and a parallelizing lens, or a light source including a parabolic reflector, and an arc tube having a luminescent center in close proximity to a focal point of the parabolic reflector.

10. The projector according to claim 9,
the arc tube being provided with a reflecting device to reflect a light, emitted from the arc tube toward the illuminated region, to the ellipsoidal reflector or the parabolic reflector.
